(19) United States
(12) Patent Application Publication
(10) Pub. No.: US 2005/0095447 A1
(43) Pub. Date: May 5, 2005

(54) High-strength aluminum alloy composite and resultant product

(76) Inventors: Stephen Baumann, Lancaster, PA (US); Raymond J. Kilmer, Lancaster, PA (US)

Correspondence Address: ECKERT SEAMANS CHERIN & MELLOTT, 600 GRANT STREET, 44TH FLOOR, PITTSBURGH, PA, 15219, US

(21) Appl. No.: 10/696,073

(22) Filed: Oct. 29, 2003

(51) Int. Cl. B32B 15/20; B32B 1/08

(52) U.S. Cl. 428/654; 138/143

(57) ABSTRACT

A high-strength aluminum alloy tubestock is for heat exchangers. The tubestock includes a core with low to moderate Si content to promote strengthening without excessively compromising corrosion resistance. A braze liner on the core exterior employs a Zn+Mg+Si water-side liner that will not experience undesirable melting during brazing. The water-side liner preferably comprises between about 0.2-0.5% Si, between about 2.5-5.0% Zn, between about 1.3-2.5% Mg, less than about 0.1% Cu, less than about 0.35% Fe and less than about 0.25% Mn, with the remainder comprising Al and tolerable impurities. The core preferably comprises between about 0.5-1.3% Mn, between about 0.1-0.3 Mg, between about 0.4-0.7% Cu, between about 0.15-0.5% Si, between about 0.01-0.25% Ti and less than about 0.5% Fe, with the remainder comprising Al and tolerable impurities. The braze liner preferably comprises an Al—Si-base alloy. A tubular member made from the foregoing tubestock is also disclosed.

### BACKGROUND OF THE INVENTION

1. Field of the Invention

The present invention relates generally to aluminum alloy composites and, more particularly, to a composite tubestock material having high post-braze strength, good corrosion resistance and good brazability. The invention also relates to a tubular member made from the tubestock material.

2. Background Information

Fluid transfer devices including, for example, heat exchangers, such as automotive radiators and heater cores, are typically fabricated from aluminum alloy composite sheet material which is subsequently rolled and brazed into a substantially tube-shaped member. For this reason, the composite sheet material is commonly referred to as tubestock. The inner material, or water-side liner, of the tubestock typically consists of anodic material which exhibits a sacrificial anode effect by being in contact with a working fluid during use of the heat exchanger and thereby substantially eliminating corrosive attack, such as, for example, pitting or crevice corrosion, on the core material therebeneath.

Tubestock typically consists of a plurality of layers. For example, typical three-layered aluminum alloy tubestock has a core fabricated from 3XXX-series aluminum alloy, such as AA3003, with a 4XXX-series braze liner on one side of the core and an anodic water-side liner, such as 3003+Zn or AA7072, on the other side of the core for internal corrosion resistance. However, these materials exhibit relatively low strength after brazing because they are fully recrystallized by the heat associated with the brazing operation and furthermore, are not capable of subsequent strengthening by mechanisms such as, for example, age-hardening.

The material can be made to exhibit an age-hardening response by incorporating Mg, Cu and Si into the alloys that compose the portion of the tubestock that will become the core and the water-side liner thereof. When Mg is added to the core alloy, however, the brazeability of the tubestock is negatively impacted in controlled atmosphere brazing (CAB) applications since Mg from the core diffuses into the braze alloy and interferes with the action of the flux in oxide removal during the brazing operation. This can result in braze joints of poor quality that could compromise the heat exchanger properties or service lifetime.

Known prior art tubestock might employ a Mg-containing water-side liner for strengthening. In addition, when combined with high Si levels in the core alloy the combination of Mg and Si can allow for precipitation strengthening of the tube after brazing. The incorporation of Zn for corrosion resistance together with Mg and possibly Si for strengthening in the water-side liner results in reduction of the melting temperature for the water-side alloy liner alloy. This can be a problem if the alloying content in the water-side liner is sufficiently high that partial melting of the liner occurs during the brazing operation.

U.S. Pat. No. 5,292,595 (Yamauchi et al.) discloses a clad aluminum alloy material having high strength and high corrosion resistance for a heat exchanger. The material has a maximum Si content of 0.2% and a maximum Zn content of 3.0% in the water-side liner.

U.S. Pat. No. 6,261,706 (Fukuda et al.) discloses aluminum alloy clad material for heat exchangers exhibiting high strength and excellent corrosion resistance. The core material has a high content of Si, 0.3 to 1.1%, for the purpose of promoting strength. The sacrificial anodic liner contains high Zn, 1.5 to 8% and Si 0.01 to 0.8%.

There is, therefore, a need to maximize the strengthening potential of tubestock having a Zn+Mg+Si water-side liner, without experiencing melting during the brazing operation and further, to maximize strength while using relatively low Si contents in the core alloy to optimize external corrosion resistance of the product.

There is room for improvement in the art of high-strength aluminum alloy composites.

### SUMMARY OF THE INVENTION

Accordingly, it is an object of the present invention to provide an aluminum alloy composite material exhibiting high post-braze strength, effective corrosion resistance and good brazability.

It is another object of this invention to maximize strength while using relatively low to moderate Si contents in the core alloy, in order to optimize the external corrosion resistance of the product It is a further object of this invention to maximize the strengthening potential of an aluminum alloy tubestock with a Zn+Mg+Si water-side liner, without experiencing undesired melting during the brazing operation.

It is another object of the present invention to provide an improved, high-strength, corrosion-resistant tubestock alloy suitable as tubing or piping material for heat exchangers, explicitly including, but not limited to automobile radiators and heater cores.

It is yet another object of the present invention to provide a composite aluminum tube made from the above-described tubestock.

These needs and others are satisfied by the present invention, which provides, among other things, an aluminum alloy composite possessing high post-braze strength while using a low to moderate Si content in the core alloy to optimize the external corrosion resistance of the product and employing a Zn+Mg+Si water-side liner without experiencing undesired melting of the water-side liner during the brazing operation.

All percentages employed herein, unless otherwise specified, are weight-percent.

As an embodiment of the invention, a composite aluminum alloy structure comprises: a braze liner; a core material; and a water-side liner. The water-side liner is preferably comprised of between about 0.2-0.5% Si and more preferably between about 0.2-0.35% Si, between about 1.3-2.5% Mg and more preferably between about 1.3-2.0% Mg, between about 2.5-5% Zn and more preferably about 3.0-4.5% Zn, less than about 0.35% Fe and more preferably less than about 0.20% Fe, less than about 0.10% Cu and more preferably less than about 0.05% Cu and less than about 0.25% Mn and more preferably less than about 0.05% Mn, with the remainder comprising Al and tolerable impurities. Tolerable impurities in the water-side liner may include, for example, up to about 0.15% Zr and the total aggregate of all impurities in the water-side liner should not exceed about 0.25%.

The core may preferably be made from between about 0.5-1.3% Mn, more preferably between about 0.5-1.0% Mn, between about 0.1-0.3% Mg, more preferably between about 0.1-0.2% Mg, between about 0.4-0.7% Cu, more preferably between about 0.5-0.7% Cu, between about 0.15-0.5% Si, more preferably between about 0.15-0.28% Si, between about 0.01-0.25% Ti, more preferably between 0.1-0.2% Ti and less than about 0.5% Fe but more preferably with less than about 0.25% Fe, with the remainder comprising Al and tolerable impurities. Tolerable impurities in the core may include, for example, up to about 0.05% Cr, up to about 0.05% Zr, but the total aggregate total of all impurities in the core should not exceed about 0.25%.

The braze liner may be made from any known or suitable brazing filler metal made from an Al—Si-base alloy, such as, for example, AA4343 or AA4045.

As another embodiment of the invention, a composite aluminum alloy tubestock, for use with a heat exchanger, comprises: a core material having a first side and a second side, the core material preferably comprised of between about 0.5-1.3% Mn, more preferably between about 0.5-1.0% Mn, between about 0.1-0.3% Mg, more preferably between about 0.1-0.2% Mg, between about 0.4-0.7% Cu, more preferably between about 0.5-0.7% Cu and between about 0.15-0.5% Si, more preferably between about 0.15-0.28% Si, between about 0.01-0.25% Ti, more preferably between about 0.1-0.2% Ti and less than about 0.5% Fe, more preferably less than about 0.25% Fe, with the remainder comprising Al and tolerable impurities; a water-side liner on the first side of the core material, the water-side liner preferably comprised of between about 0.2-0.5% Si, more preferably between about 0.2-0.35% Si, between about 1.3-2.5% Mg, more preferably between about 1.3-2.0% Mg, between about 2.5-5.0% Zn, more preferably between about 3.0-4.5% Zn, less than about 0.1% Cu, more preferably less than about 0.05% Cu, less than about 0.25% Mn, more preferably less than about 0.05% Mn and less than about 0.35% Fe, more preferably less than about 0.20% Fe, with the remainder comprising Al and tolerable impurities; and a braze liner on the second side of the core material, the braze liner comprised of a brazing filler metal consisting of an Al—Si-base alloy such as, for example, without limitation, AA4343 or AA4045.

Making the composite aluminum alloy tubestock of the present invention, may comprise the steps of casting individual DC ingots of a core material, a water-side liner alloy and a braze liner alloy. The water-side liner and braze liner ingots are separately hot-rolled to predetermined liner slab thicknesses. These thicknesses help establish the final percent of the thickness of each layer in the final product. This hot-rolling to slab may be preceded by an initial homogenization step, but such a homogenization is optional. It has been found that preheating the water-side liner ingot to a temperature between about 1000-1080° F., more preferably between 1020-1050° F. is preferred. The composite is assembled by stacking the slabs of water-side liner material and the braze liner material on either side of the cleaned core ingot and hot rolling the assembly to an intermediate gauge of about between about 4-9 mm producing a coil of material commonly referred to in the art as re-roll. The coil is subsequently processed to a tubestock of target gauge and temper by a combination of appropriate cold rolling and annealing steps.

The invention also contemplates tubes made from the above-described tubestock.

### BRIEF DESCRIPTION OF THE DRAWINGS

A full understanding of the invention can be gained from the following description of the preferred embodiments when read in conjunction with the accompanying drawings in which:

FIG. 1 is an isometric view showing the layered structure of a high-strength, corrosion resistant aluminum alloy composite material, in accordance with the present invention.

FIG. 2 is an axial view of a tubular member made from the aluminum alloy composite material of FIG. 1, before optional subsequent flattening of the tube.

### DESCRIPTION OF THE PREFERRED EMBODIMENTS

The tubestock of the present invention limits the content of Si in the core for corrosion resistance, while intentionally adding Si to the water-side liner to promote strengthening.

It has been discovered in the present invention that increasing the Si content in the water-side liner promotes strength, and that a higher Zn content in the water-side liner achieves greater cathodic protection of the underlying core.

As discussed in U.S. Pat. No. 6,261,706, post-braze strength of the tubestock with low core Si would be expected to be low. However, after the brazing operation, the tubestock composite of the present invention strengthens at room-temperature, over time. Additionally, further strengthening occurs upon exposure to temperatures that are representative of service temperatures for heat exchangers, such as, for example, automotive radiators and heater cores. In addition, the tubestock of the present invention exhibits very good internal corrosion characteristics as exemplified by the accelerated corrosion test results, discussed in detail below.

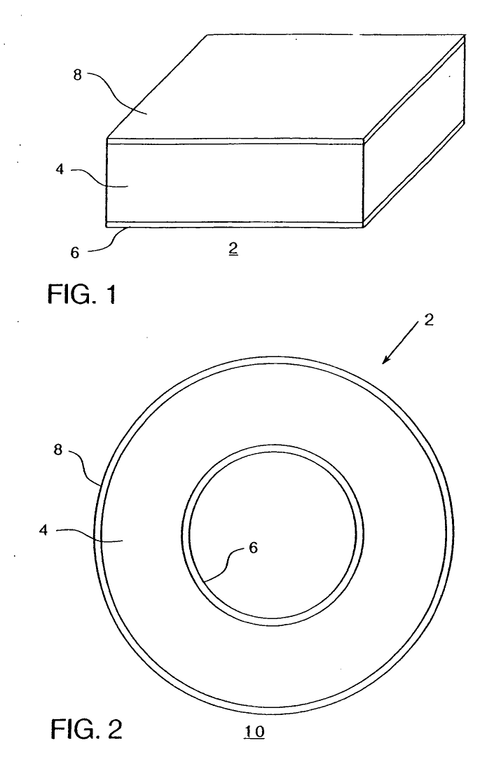

FIG. 1 illustrates an aluminum alloy composite, such as the exemplary tubestock material 2, having a core member 4 between a water-side liner 6 and a braze liner 8. The exemplary tubestock 2 may be flat rolled into a flat plate or sheet, as shown, and may have a total thickness of approximately 0.1 to 0.3 mm. However, it will be appreciated that any suitable alternative thickness may be manufactured, as specified by a customer, or end-user, such as a heat exchanger manufacturer purchasing the tubestock 2 for use within the plumbing of, for example, an automobile heat exchanger, such as, for example, a radiator or heating core (not shown). The thickness of the exemplary water-side liner 6 is preferably between about 5-30% of the overall tubestock 2 thickness. The thickness of the exemplary braze liner 8 is preferably between about 5-20% of the overall tubestock 2 thickness, with the core 4 constituting the remaining thickness.

As shown in FIG. 2, the tubestock 2 is typically subsequently rolled into a substantially tube-shaped member 10 for use, for example, within the plumbing of a heat exchanger (not shown). In such a use, the water-side liner 6 is disposed on the inside of the tube, while the braze liner 8 is disposed on the exterior of the tube, with the core 4 sandwiched therebetween. The two edges or seam of the tubestock 2, which for simplicity of illustration have not been shown, are typically sealed together by, for example, continuous seam, high-frequency induction or resistance welding (not shown), in order to form a substantially leak-proof tubular member or fluid conduit 10. The tubular member 10 is typically flattened (not shown), in order to give it a substantially oval shape, with a high-aspect ratio. It is then put through a brazing process to make the heat exchanger (not shown). Among other benefits offered by the present invention, and without limitation, it is with respect to this brazing process and subsequently thereafter, that the aforementioned improved and advantageous attributes of the tubestock of the present invention are realized.

The exemplary core material 4 includes the following composition, in weight-percent: preferably between about 0.5-1.3% Mn, more preferably between about 0.5-1.0% Mn, between about 0.1-0.3% Mg, more preferably between about 0.1-0.2% Mg, between about 0.4-0.7% Cu, more preferably between about 0.5-0.7% Cu, between about 0.15-0.5% Si, more preferably between about 0.15-0.28% Si, between about 0.01-0.25% Ti and more preferably between 0.1-0.2% Ti, with less than about 0.5% Fe but more preferably with less than about 0.25% Fe, with the remainder comprising Al and tolerable impurities. Tolerable impurities in the core may include, for example, up to about 0.05% Cr, up to about 0.05% Zr, but the total aggregate total of all impurities in the core should not exceed about 0.25%.

The exemplary water-side liner 6 is preferably comprised of between about 0.2-0.5% Si and more preferably between about 0.2-0.35% Si, between about 1.3-2.5% Mg and more preferably between about 1.3-2.0% Mg, between about 2.5-5% Zn and more preferably about 3.0-4.5% Zn, less than about 0.35% Fe and more preferably less than about 0.20% Fe, less than about 0.10% Cu and more preferably less than about 0.05% Cu and less than about 0.25% Mn and more preferably less than about 0.05% Mn, with the remainder comprising Al and tolerable impurities. Tolerable impurities in the water-side liner may include, for example, up to about 0.15% Zr and the total aggregate of all impurities in the water-side liner should not exceed about 0.25%.

The exemplary braze liner 8 may be selected from traditional aluminum braze liners well known in the art and explicitly including, but not limited to, AA4343 and AA4045. As shown, the braze liner 8 is disposed on the second or opposite side of the core 4, which when the tubestock 2 is formed into a substantially tubular member 10, as shown, is the outside of the tube.

The purpose of using these particular alloying components in the exemplary tubestock core 4 and water-side liner 6, and the reasons for the limiting the content of each therein, will now be discussed.

Core Material:

Si is incorporated in the core 4 to improve post-braze strength, but Si content is limited to enhance external corrosion. When combined with Mg, which diffuses from the anodic material, such as the exemplary water-side and braze liners 6,8, during brazing, Si forms Mg₂Si, which causes age-hardening after brazing, thereby improving strength. Si content greater than about 0.5% may result in decreased external corrosion resistance.

Fe is limited in the core 4 to avoid a detrimental effect on the corrosion resistance of the present invention. Fe content is preferably less than about 0.25%, because a higher Fe content may be detrimental to pitting corrosion resistance of the core alloy.

Cu in the core 4 improves post-braze strength. Cu also adjusts the corrosion potential of the core material thus enlarging the potential difference with respect to both the anodic water-side liner 6 and the braze liner 8, thereby improving corrosion resistance of the post-braze tube.

Mn is used in the core 4 to improve post-braze strength. Mn also adjusts the potential of the core material and enlarges the potential difference with respect to the anodic water-side liner 6, thereby improving corrosion resistance, as discussed above. Content less than about 0.5% is substantially ineffective. Content exceeding about 1.3% produces substantially no additional benefit and may decrease aging response by tying up Si.

Mg also improves post-braze strength in the core 4. However, to avoid adversely affecting brazability, Mg content is preferably less than about 0.3%, and more preferably less than about 0.2%.

Ti is used in part as a grain refiner. However, Ti is intentionally added in levels above those needed for grain refinement to improve corrosion resistance as described in U.S. Pat. No. 4,649,087. Content less than about 0.10% is substantially ineffective and content greater than about 0.25% may result in formation of coarse intermetallic particles during casting which are not desirable in the final product.

Water-Side Liner Material:

Si in the anodic material, such as the exemplary water-side liner 6, is present primarily to promote post-braze strength. From that standpoint, below about 0.20%, the effect is not significant, whereas above about 0.5% there can be issues with melting of the liner during brazing.

Fe is limited in the anodic water-side liner 6 to less than about 0.35% preferably less than about 0.20% because Fe forms cathodic intermetallic compounds that will promote pitting attack of the liner and thus reduce the internal corrosion resistance of the tube.

Cu is limited in the water-side liner because Cu would shift the corrosion potential of the liner to become less anodic which is not desirable. In addition, Cu would further reduce the melting temperature of the water-side liner. For those reasons, Cu is limited to less than about 0.10% and preferably less than about 0.05%. Mn is also limited in the water-side liner because Mn shifts the corrosion potential in the wrong direction for such a liner and because it would tend to tie up Si which is not desirable. The Si in the water-side liner is intended to remain available for combination with Mg after brazing.

Mg in the water-side liner material should preferably range from about 1.3-2.5%. If the Mg content is less than about 1.3%, the improvement in strength is substantially insignificant. Mg content above about 2.5% makes cladding to the core alloy difficult, it also would reduce the melting temperature of the water-side liner significantly. During brazing, Mg in the anodic water-side liner 6 diffuses into the core material together with some Si and creates conditions that will promote age hardening of the tube after brazing.

Zn in the water-side liner 6 lowers the corrosion potential of the liner allowing it to provide cathodic protection to the core material and thus resist pitting attack of the core material. If the content is less than about 3.0%, the anodic effect is insufficient. Additionally, Zn in excess of about 5% may result in decreasing the melting temperature of the water-side liner more than desired.

Braze Liner Material:

As discussed above, the braze liner 8 may be made from one of the braze liner materials commonly known in the art, such as, the exemplary braze liner 8, which is made from AA4343 or AA4045. It will be appreciated, however, that any suitable braze liner material could alternatively be employed.

The unexpected, advantageous attributes of the present invention are substantiated, and may be further described and understood, by reference to the following example which summarizes the post-braze strengthening and results of an accelerated corrosion test of the exemplary tubestock material.

### EXAMPLE

As an example of the aluminum alloy composite of the present invention, a 0.25 mm tubestock was fabricated having the following core, water-side liner and braze liner compositions:

TABLE 1

| | | | | | | | | % |
|---|---|---|---|---|---|---|---|---|
| Compo- | | | | | | | | thick- |
| nent | Si | Fe | Cu | Mn | Mg | Zn | Ti | ness |
| Core | 0.22 | 0.14 | 0.56 | 0.84 | 0.19 | 0.02 | 0.18 | 75 |
| Water- | 0.27 | 0.16 | 0.0 | 0.0 | 1.72 | 3.45 | 0.01 | 15 |
| side | | | | | | | | |
| liner | | | | | | | | |
| Braze | AA4343 | | | | | | | 10 |
| liner | | | | | | | | |

Processing of the tubestock involved casting the individual core, water-side liner and braze liner components as laboratory book mold ingots approximately dimensioned 2″×10″×14″. The core ingot was homogenized at bout 563° C. (1045° F.) prior to further processing. However, such homogenation is an optional step. A hot-rolling practice was applied to the water-side liner, in which it was heated to a higher temperature than typically employed in the known prior art, i.e., about 560° C. (1040° F.) and then, starting at that temperature, was hot-rolled to the appropriate cladding gauge. The braze liner was homogenized at about 490° C. (914° F.) prior to hot rolling to the desired cladding gage. The composite package was then hot rolled starting at 510° C. (950° F.). It was then cold rolled from 4.2 mm to 0.33 mm, annealed at 393° C. (739° F.), followed by final cold rolling to 0.25 mm. The braze cycle the material was exposed to included a maximum temperature of 613° C. (1,135° F.).

The post-braze tensile properties are listed below, in Table 2, for different times at room temperature as well as for times at 90° C. (194° F.). As shown, strength increased over time. These strengths are considerably higher than that for 3003 type tube which would be approximately 120 MPa UTS and 50 MPa YS.

TABLE 2

| Condition | UTS (MPa) | YS (MPa) |
|---|---|---|
| Post-braze | 145.4 | 51.7 |
| 7 days (room temperature) | 164.0 | 61.3 |
| 14 days (room temperature) | 168.1 | 65.2 |
| 21 days (room temperature) | 175.4 | 69.6 |
| 7 days 90° C. (194° F.) | 177.1 | 79.2 |
| 14 days 90° C. (194° F.) | 190.9 | 90.3 |

Internal corrosion of the tubes was evaluated by exposure to OY corrosive water. Coupon type samples were exposed for times of up to 2000 hours in an aerated beaker of OY water. The maximum or total depth of corrosive attack on the inside of the tube was evaluated. The results are shown below in Table 3. For reference, the water-side liner on the inside of the tube was about 40 microns thick.

TABLE 3

| Exposure time (hours) | Depth of Attack (microns) |
|---|---|
| 500 | 42 |
| 1000 | 45 |
| 2000 | 45 |

In addition, it is noted that the melting start temperature of the water-side liner alloy, as a monolithic component, was measured as approximately 596° C. (1,105° F.). This measurement was taken using the process well known in the art as Differential Scanning Calorimetry. Therefore, because the brazing temperature was approximately 613° C. (1,135° F.), it was expected that the water-side liner would have experienced at least partial melting. However, none was observed.

This unexpected result shows and substantiates that the composition and processing of the water-side liner alloy and/or the overall composite, resulted in advantageously improving the melting characteristics of the water-side liner. The water-side liner did not exhibit evidence of melting during the brazing operation, despite being alloyed to an amount sufficient to expect it to start melting at the brazing temperature.

Accordingly, the present invention provides a tubestock composite material, and resultant end products made therefrom, yielding advantageous unexpected attributes, such as high post-braze strength, effective external corrosion resistance and substantially no melting of the water-side liner during brazing operations.

While specific embodiments of the invention have been described in detail, it will be appreciated by those skilled in the art that various modifications and alternatives to those details, in addition to the discussed above, could be developed in light of the overall teachings of the disclosure. Accordingly, the particular arrangement disclosed are meant to be illustrative only, and not limiting as to the scope of the invention which is to be given the full breadth of the claims appended and any and all equivalents thereof.

1. A composite aluminum alloy structure comprising:
a core layer;
a water-side liner on one side of said core layer, said water-side liner comprised of between about 0.2-0.5% Si, between about 1.3-2.5% Mg, between about 2.5-5.0% Zn, less than about 0.1% Cu, less than about 0.25% Mn and less than about 0.35% Fe, with the remainder comprising Al and tolerable impurities; and
a braze liner on the other side of said core layer.

2. The composite aluminum alloy structure of claim 1 wherein said core layer is comprised of between about 0.5-1.3% Mn, between about 0.1-0.3% Mg, between about 0.4-0.7% Cu, between about 0.15-0.5% Si, between about 0.1-0.25% Ti and less than about 0.5% Fe, with the remainder comprising Al and tolerable impurities.

3. The composite aluminum alloy structure of claim 2 wherein said braze liner is made from a brazing filler metal made from an Al—Si-base alloy.

4. The composite aluminum alloy structure of claim 2 wherein said core layer is comprised of between about 0.5-1.0% Mn, between about 0.1-0.2% Mg, between about 0.5-0.7% Cu, between about 0.15-0.28% Si, between about 0.1-0.2% Ti and less than about 0.25% Fe, with the remainder comprising Al and tolerable impurities.

5. The composite aluminum alloy structure of claim 1 wherein said water-side liner is comprised of between about 0.2-0.35% Si, less than about 0.05% Cu, less than about 0.05% Mn, between about 1.3-2.0% Mg, less than about 0.2% Fe and between about 3.0-4.5% Zn, with the remainder comprising Al and tolerable impurities.

6. The composite aluminum alloy structure of claim 1 wherein said composite aluminum alloy structure is structured for use in a heat exchanger.

7. The composite aluminum alloy structure of claim 1 wherein said water-side liner is between about 5-30% of the total thickness of said structure and said braze liner is between about 5-20% of the total thickness, with the core comprising the remaining thickness.

8. The composite aluminum alloy structure of claim 1 wherein said composite aluminum alloy structure is a tubular shape.

9. The composite aluminum alloy structure of claim 8 wherein said core layer is comprised of between about 0.5-1.3% Mn, between about 0.1-0.3% Mg, between about 0.4-0.7% Cu, between about 0.15-0.5% Si, between about 0.1-0.25% Ti and less than about 0.5% Fe, with the remainder comprising Al and tolerable impurities.

10. The composite aluminum alloy structure of claim 9 wherein said braze liner is made from a brazing filler metal made from an Al—Si-base alloy.

11. A composite aluminum alloy tubestock for use with a heat exchanger, said tubestock comprising:
a core having a first side and a second side, said core comprised of between about 0.5-1.3% Mn, between about 0.1-0.3% Mg, between about 0.4-0.7% Cu, between about 0.15-0.5% Si, between about 0.1-0.25% Ti and less than about 0.5% Fe, with the remainder comprising Al and tolerable impurities;
a water-side liner on said first side of said core, said water-side liner comprised of between about 0.2-0.5% Si, less than about 0.1% Cu, less than about 0.25% Mn, less than about 0.35% Fe, between about 1.3-2.5% Mg and between about 2.5-5.0% Zn, with the remainder comprising Al and tolerable impurities; and
a braze liner on said second side of said core, said braze liner comprised of a brazing filler metal consisting of an Al—Si-base alloy.

12. The tubestock of claim 11 wherein said Ti content in said core material is between about 0.1-0.2%.

13. The tubestock of claim 11 wherein the Mn content in said core material is between about 0.5-1.0%.

14. The tubestock of claim 11 wherein the Si content in said core material is between about 0.15-0.28%.

15. The tubestock of claim 11 wherein the Mg content in said core material is between about 0.1-0.2%.

16. The tubestock of claim 11 wherein the Cu content in said core material is between about 0.5-0.7%.

17. The tubestock of claim 11 wherein the Fe content in said core material is less than about 0.25%.

18. The tubestock of claim 11 wherein the Mn content in said water-side liner less than about 0.05%.

19. The tubestock of claim 11 wherein the Zn content in said water-side liner is between about 3.0-4.5%.

20. The tubestock of claim 11 wherein the Mg content in said water-side liner is between about 1.3-2.0%.

21. The tubestock of claim 11 wherein the Cu content in said water-side liner is less than about 0.05%.

22. The tubestock of claim 11 wherein the Si content in said water-side liner is between about 0.2-0.35%.

23. The tubestock of claim 11 wherein the Fe content in said water-side liner is less than about 0.2%.

24. The tubestock of claim 11 wherein said tubestock is structured to be formed into a substantially tubular member with an interior and an exterior; wherein said water-side liner is disposed on the interior of said substantially tubular member; and wherein said braze liner is disposed on the exterior of said substantially tubular member.

25. The tubestock of claim 11 wherein said water-side liner is between about 5-30% of the total thickness of said tubestock and said braze liner is between about 5-20% of the total thickness, with the core comprising the remaining thickness.

26. The tubestock of claim 11 wherein said tubestock is of a tubular shape.

27. The tubestock of claim 26 wherein said core layer is comprised of between about 0.5-1.0% Mn, between about 0.1-0.2% Mg, between about 0.5-0.7% Cu, between about 0.15-0.28% Si, between about 0.1-0.2% Ti and less than about 0.25% Fe, with the remainder comprising Al and tolerable impurities.

28. The tubestock of claim 26 wherein said water-side liner is comprised of between about 0.2-0.35% Si, between about 1.3-2.0% Mg, between about 3.0-4.5% Zn, less than about 0.05% Cu, less than about 0.05% Mn and less than about 0.2% Fe, with the remainder comprising Al and tolerable impurities.
